(19) United States
(12) Patent Application Publication
(10) Pub. No.: US 2003/0177401 A1
(43) Pub. Date: Sep. 18, 2003

(54) System and method for using a unique identifier for encryption key derivation

(75) Inventors: Todd Weston Arnold, Charlotte, NC (US); Steven A. Bade, Georgetown, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/099,779

(22) Filed: Mar. 14, 2002

(51) Int. Cl. H04L 9/00

(52) U.S. Cl. 713/202

(57) ABSTRACT

A system and method for using a unique identifier for encryption key derivation is presented. An application sends a password and a request for an encryption key to a hardware security module (HSM). The HSM uses the password to generate a tied application data encryption key (ADEK). The tied ADEK includes an encryption key and a known value that is “tied” to the password. The HSM encrypts the tied ADEK with a hardware master key and sends it to the application. When the application requests to encrypt or decrypt data, the application sends the encrypted tied ADEK and a password to the HSM. The password corresponds to the password used to generate the tied ADEK. The HSM uses an identical hardware master key and the password to recover the ADEK. The HSM also verifies that the known value is correct.

### BACKGROUND OF THE INVENTION

1. Technical Field

The present invention relates in general to a system and method for using a unique identifier for encryption key derivation and authentication of usage of the encryption key. More particularly, the present invention relates to a system and method for using a password to match an encryption key to an application.

2. Description of the Related Art

The use of cryptographic techniques is an important part of e-business applications. E-business applications may use cryptographic techniques in a variety of ways to protect the privacy and confidentially of data, to ensure the integrity of data, and to provide user accountability through digital signature techniques.

Many servers operate in distributed environments where it is difficult to provide adequate security for sensitive processing and data. A web hosting company may own servers that other businesses use for services and transactions. For example, a web hosting company may have multiple customers' sensitive information, such as credit card information, on a single server. Web hosting services are attractive to small businesses since web hosting services provide the e-business equipment and the maintenance support for the equipment. For example, a small business may not have the investment capital to build and maintain an e-commerce infrastructure. The web hosting company can be contracted to provide e-commerce service for the small business.

A web hosting company may have sensitive data from two competing customers on a single server. A challenge found is ensuring that one company's sensitive data is protected from a second company.

Cryptographic techniques may be performed with software programs or hardware security modules. Software programs offer the benefit of not having to install new hardware on a computer system. However, cryptographic algorithms are highly intensive computationally. Using a software program which relies on a computer system's processing power may slow the overall performance of the computer system. Hardware security modules typically have an onboard co-processor to perform the cryptographic algorithms so the overall system performance is not degraded.

Hardware security modules may provide an encryption key for applications to use when an application requests to encrypt or decrypt data. The application sends the encryption key and the data to be encrypted or decrypted to the hardware security module. The hardware security module may use the encryption key to encrypt or decrypt the data without determining whether the application has the authority to use the encryption key.

A challenge found with web hosting services is determining whether an application (customer) has the authority to use an encryption key since many applications (customers) have access to the same hardware security module within a computer system.

What is needed, therefore, is way for multiple applications to share a hardware security module that maintains security between the applications.

### SUMMARY

It has been discovered that by using an encryption key in conjunction with a password to uniquely identify an application, a hardware security module can determine whether the application has the authority to use the encryption key.

The application sends a password with a request for an encryption key to the hardware security module. The hardware security module (HSM) generates a mask based upon the password and combines the mask with an application data encryption key (ADEK). An ADEK is a concatenation of an encryption key and a known value. The combining results in a Tied ADEK (TADEK) which is “tied” to the password by way of the mask that was generated using the password.

The HSM combines the TADEK with a Hardware Master Key (HMK) which results in an encrypted tied ADEK to ensure the security of the tied ADEK when the tied ADEK is sent to the application over a computer system bus. The HMK may be unique to a particular HSM, or the HMK may be shared among multiple HSM's. For example, a computer system may have multiple hardware security modules using the same hardware master key to balance the load of encryption and decryption processes across multiple hardware security modules.

Once the application acquires an encrypted tied ADEK, the application is ready to request the HSM to encrypt or decrypt data. When the application requests to encrypt or decrypt data, the application sends the encrypted tied ADEK and password to the hardware security module. The HSM combines the encrypted tied ADEK with the HSM's hardware master key. The hardware master key in this case is the decryption key corresponding to the encryption key that the module used to encrypt the tied ADEK before it was sent to the application. The combining results in a recovered tied ADEK.

The hardware security module generates a mask using the password received from the application. The mask is combined with the recovered tied ADEK which results in a recovered ADEK. The hardware security module checks the known value portion of the recovered ADEK to verify that the correct password was used. If the known value is incorrect, the hardware security module determines that the wrong password was used to retrieve the ADEK and denies the application's request to encrypt or decrypt data.

If the known value is correct, the hardware security module retrieves the generated key from the ADEK and allows the application to use the generated key to encrypt or decrypt data. The application sends data to the hardware security module for encryption or decryption. The hardware security module encrypts or decrypts the data using the generated key, and sends the data back to the application. The application may then store the data or send it to another computer over a computer network, such as the Internet.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1A is a block diagram of an application acquiring an Encrypted Tied ADEK (application data encryption key), or ETA;

FIG. 1B is a block diagram of an application using an Encrypted Tied ADEK to encrypt or decrypt data;

FIG. 2 is a flowchart of an application acquiring an encrypted tied ADEK (application data encryption key) from a hardware security module (HSM);

FIG. 3 is a detailed flowchart showing steps taken to generate an encrypted tied ADEK (ETA);

FIG. 4 is a flowchart showing steps taken in using an encrypted tied ADEK to encrypt or decrypt data;

FIG. 5 is a flowchart showing steps taken in recovering an application data encryption key (ADEK) and verifying the ADEK;

FIG. 6 is a flowchart showing steps taken in using a recovered ADEK to encrypt or decrypt data;

FIG. 7 is a data flow diagram showing various keys used for encryption and decryption; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

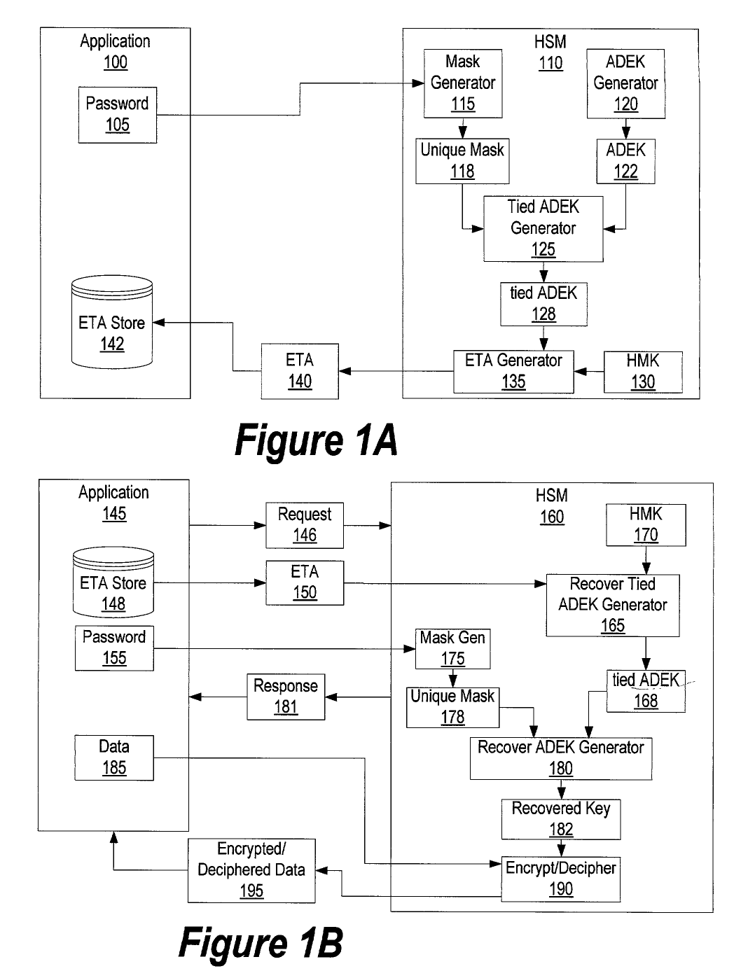

FIG. 1A is a block diagram of an application acquiring an Encrypted Tied ADEK (application data encryption key), or ETA. The application uses the ETA to ensure that unauthorized users do not have access to sensitive data. For example, application 100 may be part of an e-business that maintains commerce data. The e-business may want to ensure that the commerce data is protected, especially if the e-business uses a web hosting service.

Application 100 sends password 105 to Hardware Security Module (HSM) 110. Password 105 may have properties that increase or decrease the level of security. Password 105 may include unique identification information retrieved through various methods, such as user biometric data, smart card data, or a system-supplied value that is linked to a process or program in the computer system. For example, password 105 may include a Program Identification (PID) corresponding to the executing program.

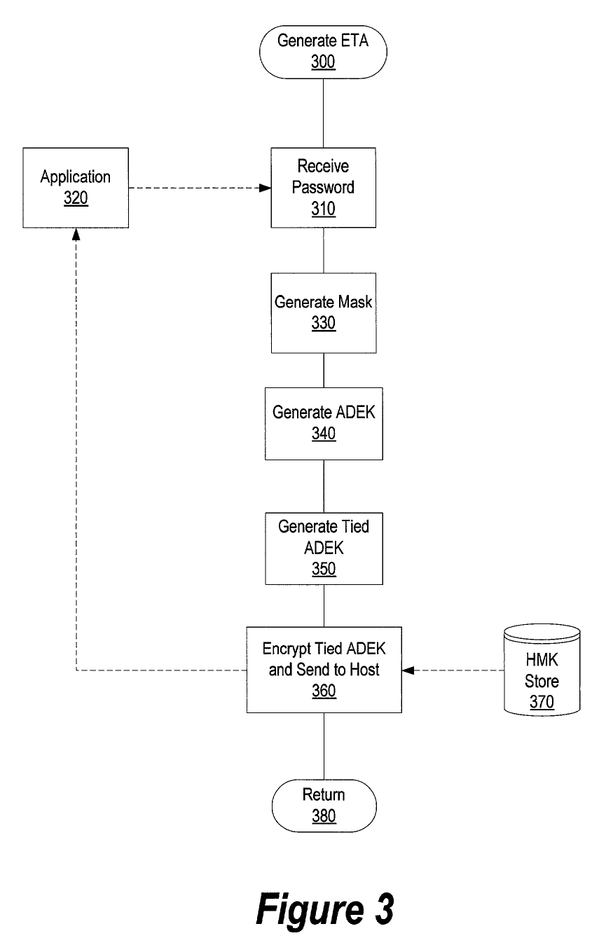

HSM 110 receives password 105 and generates a unique mask (unique mask 118) corresponding to the password (see FIG. 3 and corresponding text for further details regarding mask generation). HSM 110 may be a separate module within a computer system to perform encryption and decryption functions. In another embodiment, HSM 110 may be a software program that performs similar encryption and decryption functions.

Tied ADEK generator 125 retrieves ADEK 122 from ADEK generator 120. ADEK 122 includes a generated key concatenated with a known value (see FIG. 3 and corresponding text for further details regarding ADEK properties). The generated key may be at a level of security corresponding to the sensitivity level of the data the generated key will be protecting. For example, credit card data may be required to be encrypted with a 24 byte triple DES key, while less sensitive data, such as past ordering history, may be encrypted with an 8 byte DES key.

Tied ADEK generator 125 combines ADEK 122 with unique mask 118 to generate a tied ADEK (tied ADEK 128). Tied ADEK 128 is “tied” to password 105 by way of unique mask 118 that was generated in mask generator 115.

In order to ensure that the tied ADEK is secure enough to send over a computer network, ETA generator 135 combines tied ADEK 128 with Hardware Master Key (HMK 130) to generate an encrypted tied ADEK (ETA 140) (see FIG. 3 and corresponding text for further details regarding ETA generation). HMK 130 is an encryption key specific to HSM 110. In another embodiment, HMK 130 may be common among other hardware security modules. For example, if a system load balances encryption and decryption processes across multiple hardware security modules, each hardware security module may have the same HMK.

Application 100 receives ETA 140 and stores it in ETA store 142 for future use when application 100 requests to encrypt or decrypt data.

FIG. 1B is a block diagram of an application using an Encrypted Tied ADEK (ETA) to encrypt or decrypt data. Application 145 has previously acquired an ETA that is compatible with Hardware Security Module (HSM) 160 (see FIG. 1A and corresponding text for further details regarding ETA acquisition). Application 145 sends request 146 to hardware security module (HSM) 160 to encrypt or decrypt data. For example, application 145 may request HSM 160 to encrypt commerce data that application 145 will send over a computer network, such as the Internet.

Application 145 retrieves encrypted tied ADEK (ETA) 150 from ETA data store 148 and sends it along with password 155 to HSM 160. Password 155 is identical to the password used in the generation of ETA 150. Password 155 may be stored in memory accessible by application 145 or may be received from a system administrator at the time of the request.

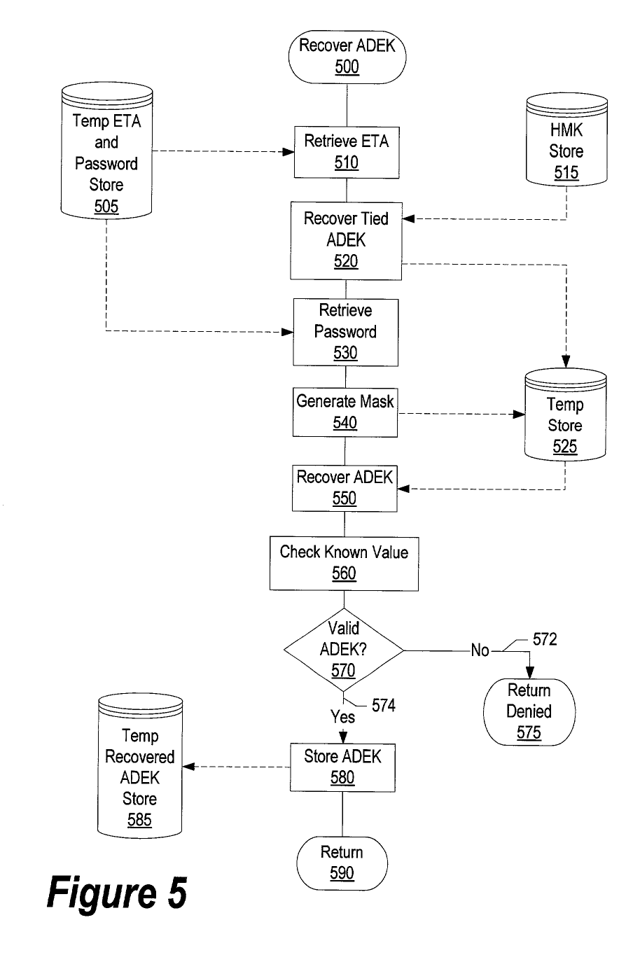

Recovered tied ADEK generator 165 receives ETA 150 and combines it with Hardware Master Key (HMK) 170 to generate a tied ADEK (tied ADEK 168) (see FIG. 5 and corresponding text for further details and corresponding text about recovering the tied ADEK). HMK 170 is an encryption key specific to HSM 160. In another embodiment, HMK 170 may be common among other hardware security modules. For example, if a system load balances encryption and decryption processes across multiple hardware security modules, each hardware security module may have the same HMK.

Mask generator 175 receives password 155 and generates a mask (unique mask 178) corresponding to the password (see FIG. 5 and corresponding text for further details regarding mask generation). Recover ADEK generator 180 combines unique mask 178 with tied ADEK 168 in to recover and verify the ADEK. The ADEK includes a generated key and a known value. The known value is checked to determine if the ADEK was recovered properly.

If the wrong password was used to generate unique mask 178, the known value will be wrong and HSM 160 sends response 181 which includes a request denied response (see FIG. 5 and corresponding text for further details regarding checking the known value). If the known value is correct, the ADEK is valid and HSM 160 sends response 181 which includes authorization for application 145 to encrypt or decrypt data.

If the ADEK is valid, application 145 sends data 185 to HSM 160 to be encrypted or decrypted using the generated key included in the ADEK (recovered key 182). Encrypt/decrypt process 190 receives data 185 and recovered key 182 and either encrypts or decrypts data 185 based upon application 145's request. For example, application 145 may wish to encrypt commerce data (data 185) that will be sent over a computer network, such as the Internet.

Encrypt/decrypt process 190 sends encrypted/decrypted data 195 to application 145. Using the example described above, application 145 may now send the encrypted data over a computer network, such as the Internet.

In one embodiment, application 145 may send additional data to HSM 160 for encryption or decryption using recovered key 182 without sending ETA 150 or password 155 within a given timeframe. For example, HSM 160 may be configured to allow application 145 to send data for encryption or decryption for ten minutes once application 145 sends an ETA and a password.

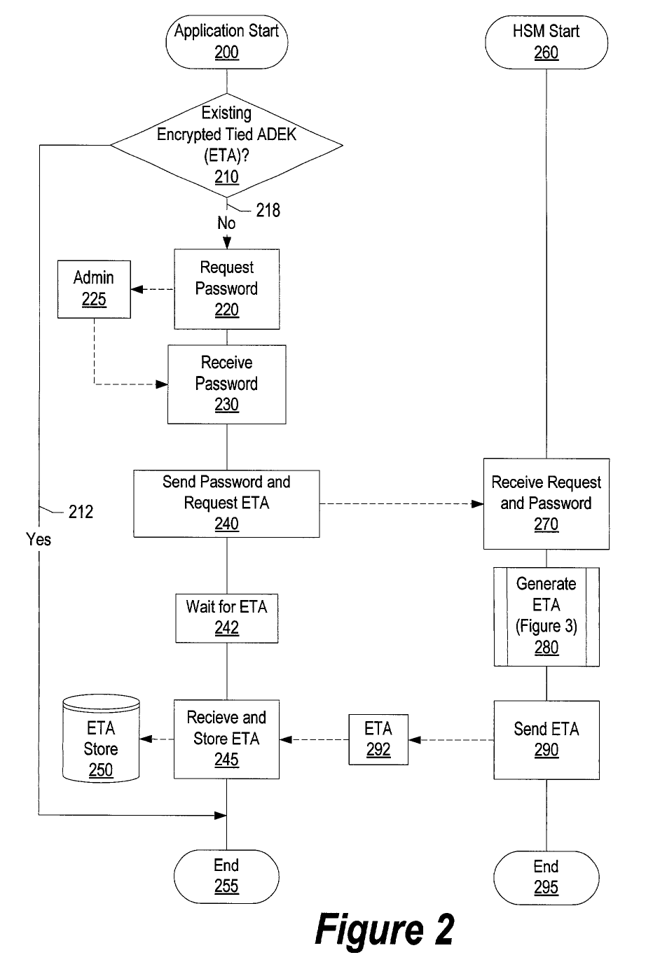

FIG. 2 is a flowchart of an application acquiring an encrypted tied ADEK (application data encryption key) from a hardware security module (HSM). Application processing commences at 200, whereupon a determination is made as to whether there is an existing encrypted tied ADEK (ETA) (decision 210). An encrypted tied ADEK (ETA) is an ADEK that is unique to the application by means of a password and is unique to a hardware security module by means of a Hardware Master Key (HMK). An application data encryption key (ADEK) includes a generated key and a known value. The generated key is used for encrypting and decrypting data and the known value is used to validate that a correct password is used in future operations described below. The hardware master key is used by the hardware security module to protect the tied ADEK before it is sent over a computer system.

In one embodiment, the application may use multiple hardware security modules with different hardware master keys. Since the encrypted tied ADEK is dependent upon the Hardware Master Key, a different encrypted tied ADEK is generated for each hardware master key. The application may make a determination as to whether it has the correct ETA that corresponds to the HMK in the HSM it requests to use. The application may make the determination by storing an HSM identifier with the ETA, such as the HSM's serial number.

If the application has an existing ETA, decision 210 branches to “Yes” branch 212 bypassing ETA acquisition steps. On the other hand, if the application does not have an existing ETA, decision 210 branches to “No” branch 218 whereupon a password request is sent to administrator 225 (step 220). In another embodiment, a password may be automatically retrieved from a storage area without requesting the password from administrator 225.

A password is received from administrator 225 at step 230. The password and a request for an encrypted tied ADEK are sent to a hardware security module (HSM) at step 240 and application processing waits for the encrypted tied ADEK (ETA) at step 242. The HSM may be a separate module in a computer system that encrypts and decrypts data. In another embodiment, the HSM may be a software program that performs similar encryption and decryption functions.

HSM processing commences at 260, whereupon the HSM receives the password and ETA request from the application (step 270). The HSM uses the password to generate an encrypted tied ADEK (pre-defined process block 280, see FIG. 3 and corresponding text for further details). The ETA is “tied” by way of the password that the application sends to the HSM. The HSM sends ETA 292 to the application at step 290, and HSM processing ends at 295.

The application receives ETA 292 and stores it in ETA store 250 for future encryption and decryption operations (step 245). ETA store 250 may be an non-volatile storage area, such as a computer hard drive.

Using the embodiment described above, ETA 292 may also include the HSM's serial number, or other identifier, in a multiple HSM computer system that uses multiple hardware master keys. In this embodiment, the application stores the HSM's serial number in ETA store 250 along with the ETA. Application processing ends at 255.

FIG. 3 is a detailed flowchart showing steps taken to generate an encrypted tied ADEK (ETA). An application uses an application data encryption key (ADEK) for encrypting and decrypting sensitive data, such as commerce data. Processing commence at 300, whereupon a password is received from application 320. The password may have certain characteristics, such as the length of the password, which corresponds with the level of security to protect data.

A mask is generated from the password at step 330. The length of the mask is equal to the length of the ADEK. The mask is used at a later step to tie the ADEK to the password.

The mask generation function makes use of multiple iterations of a Secure Hashing Algorithm 1 (SHA-1) which operates on values derived from the password. SHA-1 is an algorithm that receives an arbitrary length password and “hashes” it down to a fixed length 20 byte value called the “hash”. In general, each different password results in a different hash value which has no discernible relationship to the password itself or to hashes of similar passwords. This leads to a mask value which is also, in general, different for each password.

For the mask generation process, the password is treated as an integer value. For example, an 8-character password is treated as a 64-bit (8 byte) integer. The first 20 bytes of the mask are computed as SHA-1(password). The next 20 bytes of the mask are computed as SHA-1(password+1). The third 20 bytes of the mask are computed as SHA-1(password+3), and so on. In general, the mask is composed of multiple 20-byte segments, numbered Segment 0, Segment 1, and so on, where the value of Segment “n” is computed as SHA-1(password+n). The number of segments that are required is determined by the length of the ADEK. Enough segments are computed to provide a mask that has length equal to the length of the ADEK. If the length of the ADEK is not a multiple of 20 bytes (e.g. the length of each individual SHA-1 hash), then the last hash segment is truncated so that the total mask length is equal to the length of the ADEK.

For example, if the ADEK is 32 bytes in length, the mask is required to be 32 bytes in length. In order to derive the 32 byte mask, two SHA-1 hash segments are required. All 20 bytes of the first segment are used, providing the first 20 bytes of the mask. The first 12 bytes of the second hash segment are used to provide the last 12 bytes of the mask. In mathematical notation:

MASK₀₋₁₉=SHA-1(password), MASK₂₀₋₃₁=SHA-1(password+1)₀₋₁₁

In the above equations, the notation X_{A-B} corresponds to bytes A through B of the value X. For example, Mask₀₋₁₉ corresponds to bytes 0 through 19 of the mask, where the first (leftmost) byte is identified as byte 0.

In another embodiment, a mask may be generated using the following formula:

MASK=SHA1(PASSWORD)_{(20 bytes)}+[GENERATED PADDING]_{(n-20 bytes)}

where “+” connotes concatenation and “n” is the length of the required mask. The “generated padding” may be created using the following loop:

MASK[(SHA1_LEN+1)+i]=MASK[i]+1, for (i=0;i<(n−20),i++)

The ADEK is generated at step 340 using the following formula:

ADEK=GENERATED KEY+KNOWN VALUE

where “GENERATED KEY” is a 24 byte generated triple DES key and “KNOWN VALUE” is a predetermined value used for each ADEK. In other embodiments, the GENERATED KEY may be a higher level of encryption or a lower level of encryption compared to triple DES based on the required security level of data protection.

A 32 byte tied ADEK is generated at step 350 using the MASK and the ADEK in the following formula:

tied ADEK=MASK XOR ADEK

where XOR is an “exclusive OR” operation. The ADEK is now “tied” to the application by means of the application's password used in generating the mask.

In order to protect the tied ADEK in the computer system when it is sent to application 320, an additional level of security is added to the tied ADEK by encrypting the tied ADEK with a Hardware Master Key (HMK) located in HMK store 370 (step 360). An HMK is an encryption key which is not accessible by the user or the application and may be unique to each hardware security module. In another embodiment, the HMK may be common among security modules in a system. For example, if a system load balances encryption and decryption processes across multiple hardware security modules, each hardware security module may have the same HMK. Processing returns at 380.

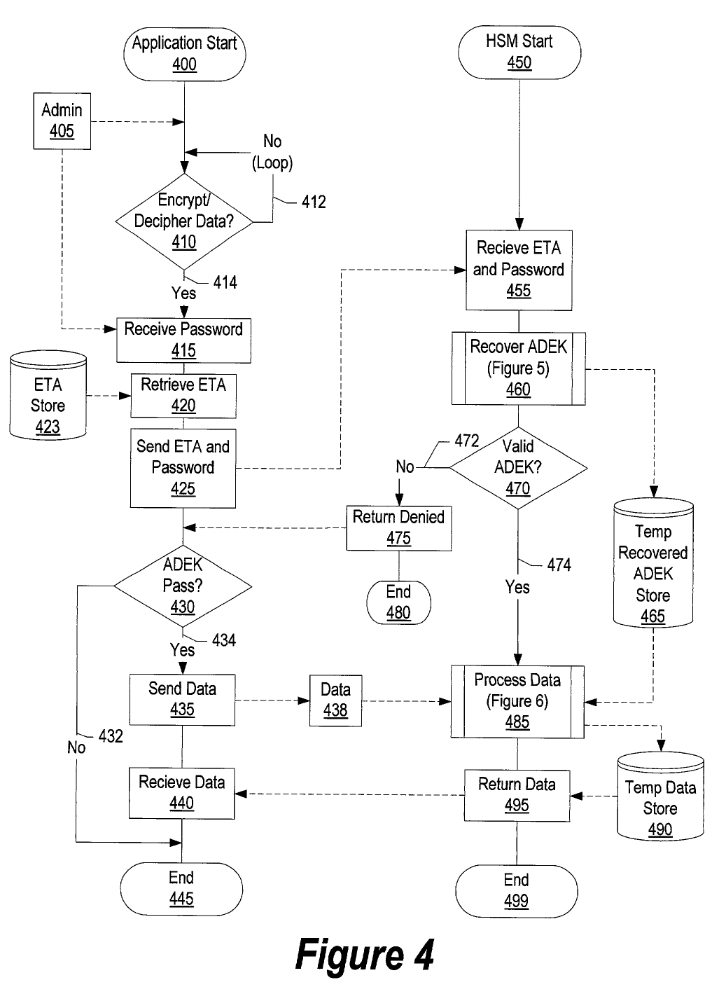

FIG. 4 is a flowchart of using an encrypted tied ADEK to encrypt or decrypt data. Application processing commences at 400, whereupon a determination is made as to whether an encryption or decryption request is received from administrator 405 (decision 410).

In another embodiment, an encryption or decryption request may come from an automated process. For example, if the application receives sensitive data, processing may be configured to automatically send an encryption request.

If an encryption or decryption request is not received, decision 410 branches to “No” branch 412 which loops back to wait for an encryption or decryption request. This looping continues until administrator 405 sends an encryption or decryption request, at which point decision 410 branches to “yes” branch 414. For example, the administrator may request to encrypt commerce data that will be sent over a computer network, such as the Internet.

A password is received from administrator 405 at step 415. An encrypted tied ADEK (ETA) is retrieved from ETA data store 423 at step 420. The ETA was originally generated using the same password received at step 415. The ETA includes a generated key that will be used to encrypt and decrypt data. The ETA and password are sent to the hardware security module at step 425. In another embodiment, the applications may have multiple ETA's for different hardware security modules. In this embodiment, the application determines which ETA to use based upon an identifier (i.e. serial number and address) stored in ETA data store 423.

Hardware security module (HSM) processing commences at 450, whereupon the password and ETA are received at step 455. Using the example above, the request may be to encrypt commerce data using the generated key within the encrypted tied ADEK. The ADEK is recovered (pre-defined process block 460, see FIG. 5 and corresponding text for further details) and stored in temporary recovered ADEK store 465. Temporary recovered ADEK store 465 may be stored on a non-volatile storage area, such as non-volatile memory.

The ADEK includes a generated key and a known value. The known value is checked to determine whether the ADEK is valid (decision 470). The known value will be correct if the correct password was used in recovering the ADEK. If an incorrect password was used, the known value will be incorrect.

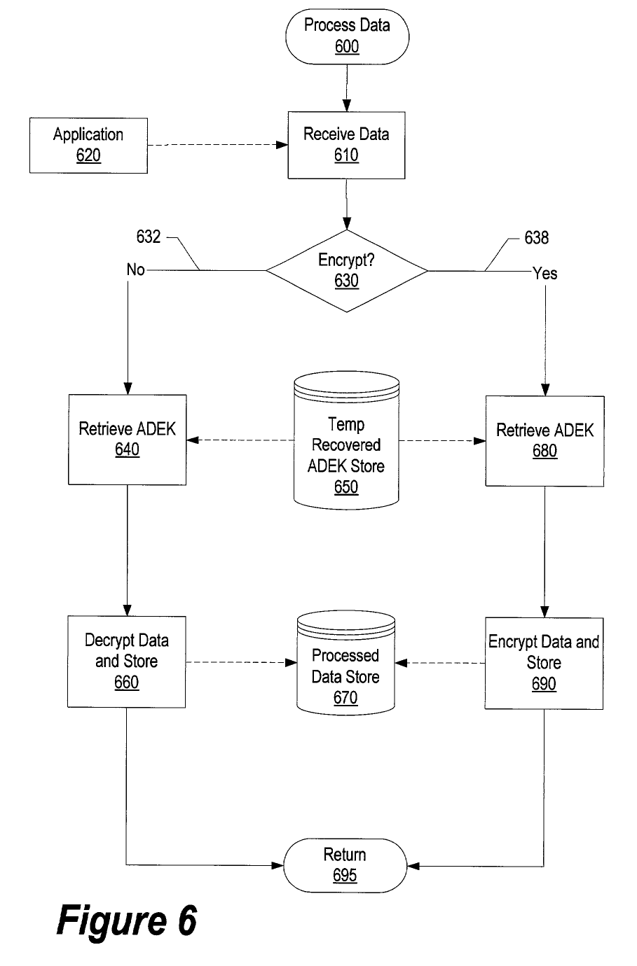

If the known value is correct, decision 470 branches to “Yes” branch 474 to encrypt or decrypt data (pre-defined process block 485, see FIG. 6 and corresponding text for further details).

On the other hand, if the known value is incorrect, decision 470 branches to “No” branch 472 whereupon a request denial is returned to the application at step 475. HSM processing ends at 480.

The application makes a determination as to whether the ADEK passed the HSM's validation decision (decision 430). If the ADEK did not pass, decision 430 branches to “No” branch 432 bypassing data encryption and decryption steps and application processing ends at 445.

On the other hand, if the ADEK did pass, decision 430 branches to “Yes” branch 434 whereupon data 438 is sent to the HSM for encryption or decryption (step 435). Using the example above, the application sends the commerce data to the HSM for encryption using the generated key included in the ADEK.

The HSM receives data 438 and retrieves the corresponding recovered ADEK from temporary recovered ADEK store 465. The HSM encrypts or decrypts the data and may store it in temporary data store 490 (pre-defined process block 485, see FIG. 6 and corresponding text for further details). In another embodiment, the HSM may send the encrypted or decrypted data directly to a memory buffer located in the corresponding host application program.

The encrypted or decrypted data is sent to the application at step 495. Using the example above, the encrypted commerce data is sent to the application. HSM processing ends at 499.

The application receives the encrypted or decrypted data at step 440. The application may either store the data or send it over a computer network, such as the Internet. Application processing ends at 445.

FIG. 5 is a flowchart showing steps taken in recovering an application data encryption key (ADEK) and verifying the ADEK. Processing commences at 500, whereupon an encrypted tied ADEK (ETA) corresponding to an application is retrieved from temporary ETA and password store 505 (step 510). Temporary ETA and password store 505 may be a temporary storage area, such as a buffer or memory location. The encrypted tied ADEK is combined with a Hardware Master Key (HMK) from HMK store 515. The combining results in a tied ADEK (step 520) which is stored in temporary store 525. Temporary store 525 may be a temporary storage area, such as a buffer. The combining may be a simple “exclusive OR” technique or the combining may be a more sophisticated algorithm.

A password corresponding to the application is retrieved from temporary ETA and password store 505 at step 530. The password is used to generate a 32 byte mask (see FIG. 3 and corresponding text for further details regarding mask generation). In another embodiment, the mask may be more than 32 bytes or less than 32 bytes and may be generated using a different algorithm depending upon the required security level of data protection.

The ADEK is recovered (step 550) by combining the mask and tied ADEK using the following formula:

ADEK=mask XOR tied ADEK

where XOR is an “exclusive OR” operation.

The ADEK includes two parts which are a generated key and an eight byte known value (see FIG. 3 and corresponding text for further details regarding properties of the generated key and the known value).

In order to ensure that the proper mask was used (i.e. the correct password) to recover the tied ADEK, processing checks the known value of the recovered ADEK at step 560. For example, if the wrong password was used to generate the mask, the known value will be wrong when the mask is exclusive or'ed with the tied ADEK.

A determination is made as to whether the known value is correct. For example, if the original known value is “02EA4F6251B649D5”, then the recovered known value should be “02EA4F6251B649D5”. If the recovered known value is not correct, decision 570 branches to “No” branch 572 whereupon an request denied is returned to the application at 575.

On the other hand, if the recovered known value is correct, decision 570 branches to “Yes” branch 574 whereupon the recovered ADEK is stored in temporary recovered ADEK store 585 (step 580). Temporary recovered ADEK store may be a temporary storage area, such as a buffer. Processing returns at 590.

FIG. 6 is a flowchart showing steps taken in using a recovered ADEK to encrypt or decrypt data. Processing commences at 600, whereupon data is received from application 620 (step 610). For example, application 620 may be a web server which requests to encrypt or decrypt commerce data.

A determination is made as to whether application 620 requests to encrypt data or decrypt data (decision 630). If application 620 requests to decrypt data, decision 630 branches to “No” branch 632. Using the example above, the application may send encrypted commerce data which is to be decrypted.

The ADEK corresponding to application 620 is retrieved from temporary recovered ADEK store 650 at step 640. The ADEK includes two parts which are a generated key and a known value. The data is decrypted using the generated key and may be stored in processed data store 670 at step 660. Using the example above, the commerce data may be decrypted with the generated key using an “exclusive OR” function, or may be decrypted using a more complex algorithm. Processed data store 670 may be a non-volatile storage area, such as a computer hard drive. In another embodiment, the decrypted data may be sent directly to a memory buffer located in the corresponding host application program.

If the application requests to encrypt data, decision 630 branches to “Yes” branch 638 whereupon the ADEK corresponding to application 620 is retrieved from temporary recovered ADEK store 650 at step 680. The data is encrypted (step 690) using the generated key included in the ADEK and may be stored in processed data store 670. For example, the data may be encrypted using a simple “exclusive OR” technique, or the data may be encrypted with the generated key using a more complex algorithm. In another embodiment, the encrypted data may be sent directly to a memory buffer located in the corresponding host application program. Processing returns at 695.

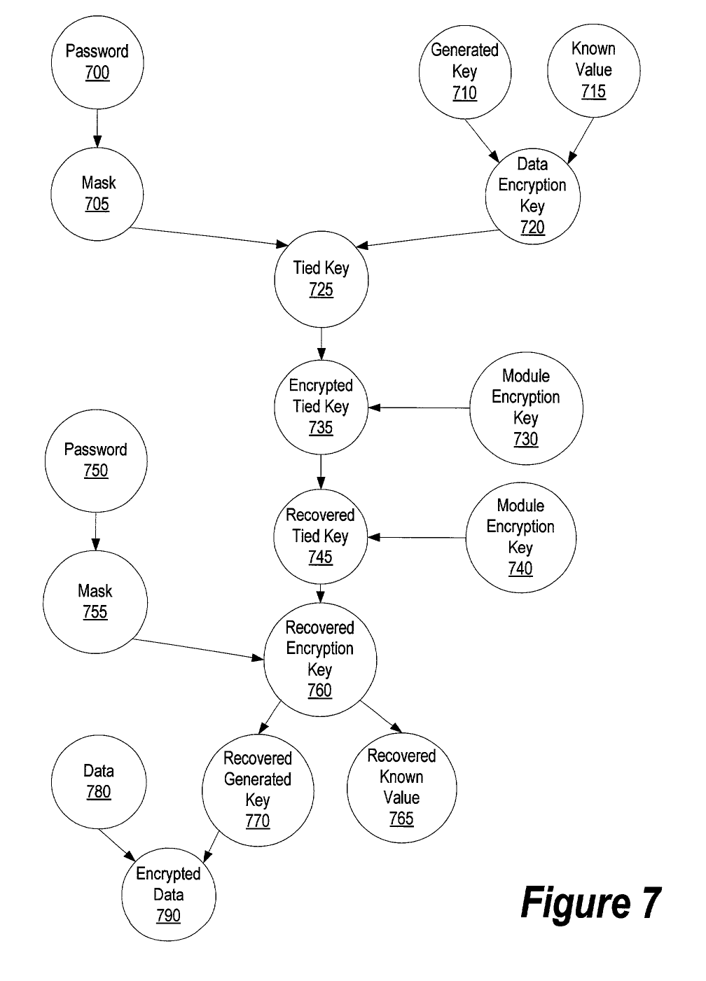

FIG. 7 is a data flow diagram showing various keys used for encryption and decryption. An application provides password 700 which is used to generate mask 705 (see FIG. 3 and corresponding text for further details regarding mask generation). Generated key 710 is combined with known value 715 to create data encryption key 720 (i.e. Application Data Encryption Key (ADEK)). Mask 705 is combined with data encryption key 720 to create tied key 725 (i.e. Tied ADEK (TADEK)) (see FIG. 3 and corresponding text for further details regarding initial tied key generation).

Tied key 725 is combined with module encryption key 730 (i.e. Hardware Master Key (HMK)) to create encrypted tied key 735 (i.e. Encrypted Tied ADEK (ETA)) (see FIG. 3 and corresponding text for further details regarding encrypted tied key generation). Encrypted tied key 735 is secure and may be sent over a computer system bus to the application.

When the application requests to encrypt or decrypt data, the application provides encrypted tied key 735. Encrypted tied key 735 is decrypted using module encryption key 740 (Hardware Master Key (HMK)) which results in recovered tied key 745 (see FIG. 5 and corresponding text for further details regarding tied key recovery).

The application provides password 750 which is used to generate mask 755 (see FIG. 3 and corresponding text for further details regarding mask generation). Mask 755 is combined with recovered tied key 745 to create recovered encryption key 760 (i.e. recovered ADEK) (see FIG. 5 and corresponding text for further details regarding encryption key recovery).

Recovered encryption key includes two parts which are recovered known value 765 and recovered generated key 770. Recovered known value 765 is used to validate the correct password (password 750) was used to recover the encryption key (recovered encryption key 760). Recovered generated key 770 is used to encrypt data 780 which results in encrypted data 790. In another embodiment, recovered generated key 770 may be used to decrypt data 780 (data 780 was previously encrypted) which results in decrypted data.

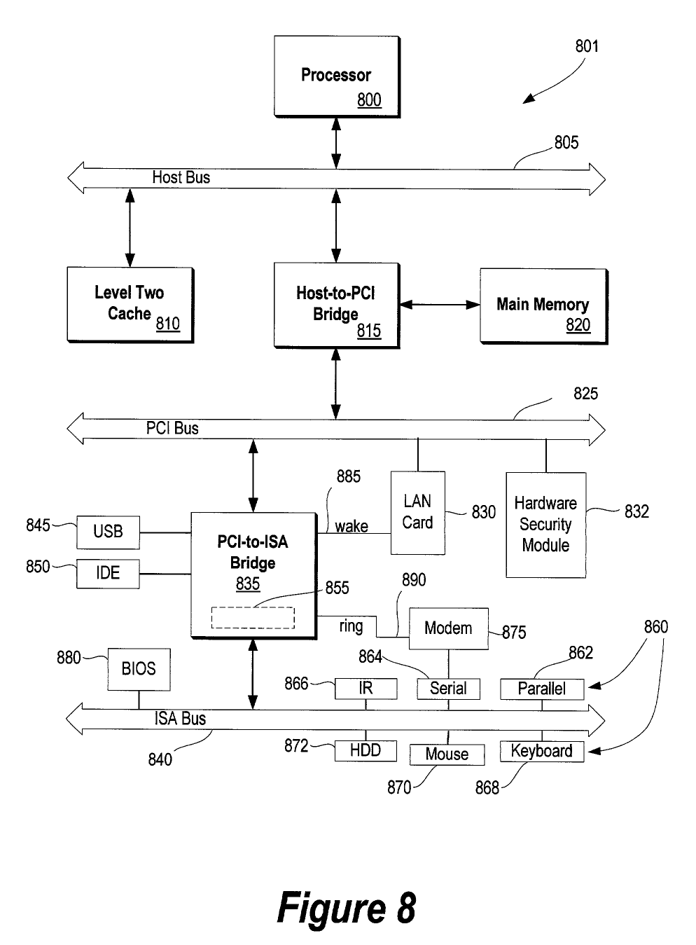

FIG. 8 illustrates information handling system 801 which is a simplified example of a computer system capable of performing the server and client operations described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830, and hardware security module 832. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (HDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 to another computer system to copy files over a network, LAN card 830 is coupled to PCI bus 825 and to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for securing data, said method comprising:
receiving a first password corresponding to a software application;
generating a first mask value based on the first password;
combining the first mask value with a first encryption key, wherein the first encryption key is derived from a generated key and a known value, the combining resulting in a tied key;
receiving a second password corresponding to the software application;
generating a second mask value based on the second password;
separating a recovered encryption key from the tied key using the second mask value, the recovered encryption key including a recovered generated key and a recovered known value; and
encrypting data using the recovered generated key.

2. The method as described in claim 1 further comprising:
encrypting the tied key using a second encryption key, the encrypting resulting in a first encrypted tied key; and
returning the first encrypted tied key to the software application.

3. The method as described in claim 2 further comprising:
receiving a second encrypted tied key; and
combining the second encrypted tied key with the second encryption key, the combining resulting in a recovered tied key.

4. The method as described in claim 2 further comprising:
determining whether a matched encryption tied key is available corresponding to the second encryption key; and
sending the matched encryption tied key to a security module in response to the determination.

5. The method as described in claim 2 further comprising:
determining whether a matched encrypted tied key is available corresponding to the second encryption key; and
sending the first password to a security module in response to the determination.

6. The method as described in claim 1 further comprising:
determining whether the recovered known value is correct; and
processing a data file based on the determination.

7. The method as described in claim 6 wherein the processing is selected from the group consisting of encrypting the data file using the recovered generated key and decrypting the data file using the recovered generated key.

8. An information handling system comprising:
one or more processors;
a memory accessible by the processors;
one or more nonvolatile storage devices accessible by the processors;
a hardware security module accessible by the processors;
a data security tool for securing data using the hardware security module, the data security tool including:
means for receiving a first password corresponding to a software application;
means for generating a first mask value based on the first password using the hardware security module;
means for combining the first mask value with a first encryption key using the hardware security module, wherein the first encryption key is derived from a generated key and a known value, the combining resulting in a tied key;
means for receiving a second password corresponding to the software application;
means for generating a second mask value based on the second password using the hardware security module;
means for separating a recovered encryption key from the tied key using the second mask value, the recovered encryption key including a recovered generated key and a recovered known value; and
means for encrypting data using the recovered generated key.

9. The information handling system as described in claim 8 further comprising:
means for encrypting the tied key using a second encryption key, the encrypting resulting in a first encrypted tied key; and
means for returning the first encrypted tied key to the software application.

10. The information handling system as described in claim 9 further comprising:
means for receiving a second encrypted tied key; and
means for combining the second encrypted tied key with the second encryption key using the hardware security module, the combining resulting in a recovered tied key.

11. The information handling system as described in claim 9 further comprising:
means for determining whether a matched encryption tied key is available corresponding to the second encryption key; and
means for sending the matched encryption tied key to the hardware security module in response to the determination.

12. The information handling system as described in claim 8 further comprising:
means for determining whether the recovered known value is correct; and
means for processing a data file corresponding to the determination.

13. The information handling system as described in claim 12 wherein the means for processing is selected from the group consisting of a means for encrypting the data file using the recovered generated key and a means for decrypting the data file using the recovered generated key.

14. A computer program product stored in a computer operable media for securing data, said computer program product comprising:
means for receiving a first password corresponding to a software application;
means for generating a first mask value based on the first password;
means for combining the first mask value with a first encryption key, wherein the first encryption key is derived from a generated key and a known value, the combining resulting in a tied key;
means for receiving a second password corresponding to the software application;
means for generating a second mask value based on the second password;
means for separating a recovered encryption key from the tied key using the second mask value, the recovered encryption key including a recovered generated key and a recovered known value; and
means for encrypting data using the recovered generated key.

15. The computer program product as described in claim 14 further comprising:
means for encrypting the tied key using a second encryption key, the encrypting resulting in a first encrypted tied key; and
means for returning the first encrypted tied key to the software application.

16. The computer program product as described in claim 15 further comprising:
means for receiving a second encrypted tied key; and
means for combining the second encrypted tied key with the second encryption key, the combining resulting in a recovered tied key.

17. The computer program product as described in claim 15 further comprising:
means for determining whether a matched encryption tied key is available corresponding to the second encryption key; and
means for sending the matched encryption tied key to a security module in response to the determination.

18. The computer program product as described in claim 15 further comprising:
means for determining whether a matched encrypted tied key is available corresponding to the second encryption key; and
means for sending the first password to a security module in response to the determination.

19. The computer program product as described in claim 14 further comprising:
means for determining whether the recovered known value is correct; and
means for processing a data file corresponding to the determination.

20. The computer program product as described in claim 19 wherein the means for processing is selected from the group consisting of a means for encrypting the data file using the recovered generated key and a means for decrypting the data file using the recovered generated key.
